(19) United States
(12) Patent Application Publication
(10) Pub. No.: US 2023/0112740 A1
(43) Pub. Date: Apr. 13, 2023

(54) TEXTUAL CONTENT EVALUATION USING MACHINE LEARNED MODELS

(71) Applicant: MOTIVE8 LEARNING LIMITED D/B/A PROGRESSAY, London (GB)

(72) Inventors: Moktar Alqaderi, London (GB); Sainab Sharif, London (GB)

(21) Appl. No.: 18/045,039

(22) Filed: Oct. 7, 2022

Related U.S. Application Data
(60) Provisional application No. 63/253,887, filed on Oct. 8, 2021.

(51) Int. Cl. G06F 40/216; G06F 40/58

(52) U.S. Cl. CPC G06F 40/216; G06F 40/58

(57) ABSTRACT

The present disclosure describes systems and methods for evaluating content using a machine learned model. In some examples, a supervised learning machine learned model may be used. In some examples, an unsupervised learning machine learned model may be used. In operation, a computing device may receive textual content from a user device. The computing device may, using the machine learned model, analyze the textual content and determine a content evaluation, in some examples, including a content score, for the textual content. In some examples, the analysis includes extracting features, metrics, or combinations thereof, of the textual content.

### CROSS-REFERENCE TO RELATED APPLICATION(S)

This patent application claims the benefit of the Applicant's U.S. Provisional Application No. 63/253,887, filed Oct. 8, 2021, titled “TEXTUAL CONTENT EVALUATION USING MACHINE LEARNED MODELS,” the entire contents of which is incorporated by reference as if fully set forth herein.

### FIELD

The present disclosure relates generally to systems and methods for content evaluation, such as evaluating textual content for scoring or marking purposes.

### BACKGROUND

In recent years, the application of artificial intelligence (AI), and more specifically, machine learning (an application of AI) to education has transformed and fundamentally changed the education system, from teaching and learning, to research and exploration. For example, machine learning has helped students better enjoy the learning process and have a better understanding of learning goals and outcomes with their instructors. Machine learning has also aided educators to spot struggling or at-risk students earlier and take, in some instances, corrective action to improve success and retention. Machine learning has further assisted researchers in accelerating their research endeavors aimed at new discoveries and deeper insights. From kindergarten and primary school, to higher education and beyond, machine learning has had a positive impact and global reach on education. Despite its positive impact, machine learning's application to education is incomplete, and there remain notable shortcomings and unaddressed issues.

In particular, a gap remains with respect to using machine learning to assist with instructor efficiency in grading, as well as accuracy and reliability of assessment, of a student's work (e.g., essays, etc.). In this regard, while machine learning has had a positive impact on many aspects of the education pipeline, many instructors, teachers, and the like, continue to rely exclusively on manual grading for evaluation of a student's work. In some instances, manual review and evaluation of a student's work is time consuming, variable based on who the evaluator is, and can lead to inconsistent results across students.

Accordingly, it may be desirable to facilitate a reduction in time spent on, and enhance the accuracy and reliability of, content evaluation using machine-learning based marking.

### SUMMARY

The present application includes a method for content evaluation, such as evaluating textual content for scoring or marking purposes. The method includes analyzing, by a processor communicatively coupled to memory, textual content using a machine learned model trained using at least a plurality of textual training content, wherein the analysis comprises extracting features, metrics, or combinations thereof of the textual content, wherein the textual content comprises one or more words of a plurality of words, and wherein each textual training content of the plurality of textual training content comprises a training evaluation; and based at least in part on the analysis including the extracted features and metrics, automatically determining, by the processor, a content evaluation for the textual content.

Additionally, a system for evaluating textual content is disclosed. The system includes a processor, communicatively coupled to a user device, and configured to receive textual content produced by a user from the user device, wherein the textual content comprises one or more words of a plurality of words and is generated in response to a prompt based on a topic. The processor, communicatively coupled to memory, is further configured to analyze the textual content using a machine learned model. The processor is further configured to, based on the analysis, determine a content evaluation for the textual content, wherein the content evaluation is based in part on an assessment of an understanding by the user of the topic.

Moreover, a non-transitory computer readable medium encoded with instructions for content evaluation is disclosed. The non-transitory computer readable medium includes analyzing the textual content using a machine learned model trained using textual training content; and based at least in part on the analysis, automatically determining a content evaluation for the textual content.

### BRIEF DESCRIPTION OF THE DRAWINGS

Reference is now made to the following descriptions taken in conjunction with the accompanying drawings, in which:

FIG. 1 is a schematic illustration of an environment in which a system for content evaluation using machine learning operates, in accordance with examples described herein;

FIG. 2 is a flowchart of a method for content evaluation using machine learning, in accordance with examples described herein;

FIG. 3 is a flowchart of a method for content evaluation using a supervised learning machine learned model, in accordance with examples described herein;

FIG. 4 is a flowchart of a method for content evaluation using an unsupervised learning machine learned model, in accordance with examples described herein;

FIG. 5 is a block diagram of ground truth content in a structured relational knowledge graph in a relational data store, in accordance with examples described herein;

FIG. 6 is a schematic diagram of an example computing system, in accordance with examples described herein; and,

FIG. 7 is a block diagram illustrating content evaluation using machine learning as described herein.

### DETAILED DESCRIPTION

Certain details are set forth herein to provide an understanding of described embodiments of technology. However, other examples may be practiced without various ones of these particular details. In some instances, well-known computing system components, virtualization components, circuits, control signals, timing protocols, and/or software operations have not been shown in detail in order to avoid unnecessarily obscuring the descried embodiments. Other embodiments may be utilized, and other changes may be made, without departing from the spirit or scope of the subject matter presented herein.

The present disclosure generally relates to systems and methods for content evaluation, and more specifically, for analyzing textual content, such as essays, written work product, or the like, to determine a textual content evaluation, comprising a content score, using a machine learned model trained via supervised learning, unsupervised learning, or combinations thereof. As used herein, textual content can be written and/or transcribed language generated by a user of a user device, such as an essay generated by a student taking an examination.

For example, a computing device including a processor, communicatively coupled to a user device, can receive textual content from the user device, where the textual content includes a plurality of words. The computing device having a content evaluation machine learned model and communicatively coupled to the user device analyzes the textual content including extracting features, metrics, or combinations thereof, of the textual content. In some examples, the textual content can include academic content, written content, one or more images, an essay, an article, a dissertation, a manuscript, a paper, a thesis, a treatise, an exposition, a composition, or combinations thereof. In some instances, the textual content can be generated in response to a prompt or question, such as in response to an examination on a particular subject, and can be used to demonstrate a user understanding of the particular subject. For example, the textual content can be generated by students during an examination process for qualifying examinations (e.g., bar exam, accounting qualifications, etc.) and/or within an academic environment, such as school.

The computing device having the content evaluation machine learned model and communicatively coupled to the user device, based at least in part on the analysis including the extracted features and metrics, determines a content evaluation for the textual content. In some examples, the content evaluation machine learned model can be an unsupervised learning machine learned model, and can be trained using textual training content. In some examples, the content evaluation machine learned model can be a supervised learning machine learned model, and can be trained using the textual training content. In some examples, the textual training content can include one or more words of a plurality of words. In some examples, the textual training content can include academic content, written content, one or more images, an essay, an article, a dissertation, a manuscript, a paper, a thesis, a treatise, an exposition, a composition, or combinations thereof.

In some examples, the content evaluation can include a content score out of a plurality of content scores for the textual content. In some examples, the content score can be a continuous variable. In some examples, the content score can be selected from a plurality of predetermined values. Additionally and/or alternatively, in some examples, the content evaluation can include comments regarding the textual content.

A display, communicatively coupled to the processor, can, in some examples, provide the content evaluation for manual updating, where the manual updating, in some examples, can include alteration of the content evaluation. In some examples, the alteration of the content evaluation can include an alteration of the content score. In some examples, based on the determined content evaluation, the computing device can provide recommendations for corrective actions to be taken by the instructor (e.g., teacher, evaluator, grader, etc.).

The content evaluation can be used to automatically, and accurately, analyze textual content, which can allow for consistency across work by multiple users, faster analysis, and the like. In particular, as compared to the manual grading process currently performed by many teachers, institutions, and evaluators, the systems and methods described here can result in a more accurate, fair, and fast evaluation across many different subjects or topics.

Specifically, current methods of textual content evaluation include manual review, analysis, and scoring of content. Existing automated evaluation methods typically are unable to evaluate textual content, and instead are limited to simplistic evaluations of numerical content or multiple choice answers. However, while time-tested, manual grading suffers from various shortcomings, including unreliability, inefficiency, and inconsistency. With respect to manual grading and reliability, according to recent research, only 52% of students receive a “definitive” General Certificate of Secondary Education grade (e.g., mark, score, etc.) in English. This means that almost half of students may have received a different grade than initially awarded, had a different evaluator (e.g., teacher, instructor, professor, grader, examiner, etc.) graded their exam (e.g., content). Similarly, additional research shows that up to 25% of student exam grades would be changed if the exams were graded by a senior evaluator. Additionally, and with respect to efficiency, additional studies have shown that over 61% of teachers think they spend too much time grading. Moreover, manual content review and other grading is limited by the abilities of a human evaluator, who can only attend to a single textual content at a time. For example, a teacher grading multiple essays must review each essay in sequence and manually evaluate each essay. By contrast, the disclosed systems and methods increase efficiency, for example, by allowing for multiple textual content to be evaluated in parallel and in a short amount of time (e.g., seconds or minutes).

Techniques described herein include a content evaluation system for analyzing textual content to determine a textual content evaluation, the textual content evaluation including a content score. In some examples, a machine learned model trained via supervised learning, unsupervised learning, or combinations thereof, is used to analyze the textual content and determine the content evaluation.

The user device can send textual content to a computing device for analysis. In some examples, and as described, the textual content can include one or more words of a plurality of words. In some examples, the textual content can include academic content, written content, one or more images, an essay, an article, a dissertation, a manuscript, a paper, a thesis, a treatise, an exposition, a composition, or combinations thereof. In some examples, the textual content can be sent by a user of the user device, such as a student, customer, administrator, teacher, tutor, teaching assistant, or the like.

The computing device can be communicatively coupled to the user device and can comprise a content evaluation machine learned model trained using supervised learning, unsupervised learning, or combinations thereof, to analyze and evaluate textual content. As should be appreciated, and as used herein, machine learning is meant to encompass artificial intelligence and other related technologies. In some instances, the computing device can receive the textual content and the content evaluation machine learned model can analyze the textual content. In some instances, based on the analysis, the content evaluation machine learned model can determine a content evaluation for the textual content.

In some examples, a supervised learning machine learned model can perform the analysis of the textual content. In some examples, the analysis of the textual content by the supervised learning machine learned model can be based on performing metric extraction on the textual content, where the metric extraction includes extracting reading metrics, writing metrics, or combinations thereof, from the textual content. In some examples, the analysis of the textual content by the supervised learning machine learned model can be based on performing feature extraction on the textual content, wherein the feature extraction includes determining and/or triangulating the occurrence of language devices, inference verbs, common phrases, or combinations thereof in the textual content. In some examples, the analysis of the textual content by the supervised learning machine learned model can be based on identifying and/or extracting one or more additional and/or alternative linguistic tokens. As should be appreciated, while feature spotting is discussed, it should be appreciated that triangulation can also be used to perform certain functions described herein, including determining the occurrence of various linguistic tokens. In some examples, triangulation occurs using one or more various classifiers, including but not limited to Naïve Bayes classifiers, Multinomial Naïve Bayes classifiers, Gaussian Naïve Bayes classifiers, or combinations thereof.

In some examples, the analysis of the textual content by the supervised learning machine learned model can be based on performing term frequency-inverse document frequency transformation (TF-IDF) on the textual content, wherein the TF-IDF includes determining a numerical statistic indicative of a level of importance for each of the one or more of words of the plurality of words in the textual content. Additionally and/or alternatively, in some examples, the analysis of the textual content by the supervised learning machine learned model can be based on performing word embedding, Bidirectional Encoder Representations from Transformers (BERT), Chunking, tokenization, lemmatization, other similar techniques, or combinations thereof.

In some examples, evaluation and/or analysis of the textual content by the supervised learning machine learned model can be based on methods, not exclusive to natural language processing (NLP), to determine values indicative of a level of importance for each of the one or more words of the plurality of words in the textual content, including but not limited to the above-recited techniques and/or methods.

In some examples, the analysis of the textual content by the supervised learning machine learned model can be based on performing relationship extraction on the textual content, wherein the relationship extraction includes detecting and classifying semantic relationship for each of the one or more words of the plurality of words in the textual content and each of a plurality of words in the plurality of textual training content. In some examples, the analysis of the textual content by the supervised learning machine learned model can be based on performing relationship extraction on the textual content, wherein the relationship extraction includes an lexical analysis based at least on detecting and classifying semantic relationships between lexical tokens for each of the one or more lexical tokens of the plurality of lexical tokens in the textual content and each of a plurality of lexical tokens in the plurality of textual training data.

In some examples, the analysis of the textual content by the supervised learning machine learned model can be based on performing semantic similarity on the textual content, wherein the semantic similarity includes determining a lexicographical similarity distance between each of the one or more words of the plurality of words in the textual content and each of a plurality of words in the plurality of textual training content, wherein the distance is indicative of similarity. In some examples, performing semantic similarity on the textual content can be based at least in part on determining a lexicographical similarity distance between each of the one or more lexical tokens of the of the plurality of lexical tokens in the textual content and each of the plurality of lexical tokens in the plurality of textual training content, wherein the distance is indicative of similarity.

In some examples, the analysis of the textual content by the supervised learning machine learned model can be based on performing one or more of metric extraction, feature extraction, TF-IDF transformation, relationship extraction, or semantic similarity. Additionally and/or alternatively, in some examples, the analysis of the textual content by the supervised learning machine learned model can be based on one or more natural language models, including but not limited to, metric extraction, Chunking, lemmatization, parts of speech (POS) tagging, feature extraction, TF-IDF transformation, relationship extraction, semantic similarity, combinations thereof, and/or other similar techniques. In some examples, the supervised learning machine learned model can determine, based at least on one or more of the metric extraction, TF-IDF transformation, relationship extraction, semantic similarity, or combinations thereof, the content evaluation for the textual content. In some examples, the content evaluation determined by the supervised learning machine learned model can include a content score out of a plurality of content scores for the textual content, where the content score is a continuous variable (e.g., 3.8, 4.5, 5.9, 0.12, etc.), such as a variable within a predefined numerical range. In other words, the content score can be uniquely generated based on the assessment. Additionally and/or alternatively, in some examples, the content evaluation can include comments regarding the textual content.

In some examples, an unsupervised learning machine learned model can perform the analysis of the textual content. In some examples, the analysis of the textual content by the unsupervised learning machine learned model can be based on performing metric extraction on the textual content, where the metric extraction includes extracting reading metrics, writing metrics, or combinations thereof, from the textual content. In some examples, the analysis of the textual content by the unsupervised learning machine learned model can be based on performing feature extraction on the textual content, wherein the feature extraction includes determining and/or triangulating the occurrence of language devices, inference verbs, common phrases, or combinations thereof in the textual content. In some examples, the analysis of the textual content by the unsupervised learning machine learned model can be based on identifying and/or extracting one or more additional and/or alternative linguistic tokens. As should be appreciated, while feature spotting is discussed, it should be appreciated that triangulation can also be used to perform certain functions described herein, including determining the occurrence of various linguistic tokens. In some examples, triangulation can occur using one or more various classifiers, including but not limited to Naïve Bayes classifiers, Multinomial Naïve Bayes classifiers, Gaussian Naïve Bayes classifiers, or combinations thereof.

In some examples, the analysis of the textual content by the unsupervised learning machine learned model can be based on performing relationship extraction on the textual content, wherein the relationship extraction includes detecting and classifying one or more semantic relationships for each of the one or more words of the plurality of words in the textual content and each of a plurality of words in the plurality of textual training content. In some examples, the analysis of the textual content by the unsupervised learning machine learned model can be based on performing relationship extraction on the textual content, wherein the relationship extraction includes a lexical analysis based at least on detecting and classifying semantic relationships between lexical tokens for each of the one or more lexical tokens of the plurality of lexical tokens in the textual content and each of a plurality of lexical tokens in the plurality of textual training data.

In some examples, the analysis of the textual content by the unsupervised learning machine learned model can be based on performing one or more of the metric extraction, feature extraction, relationship extraction, or combinations thereof, and/or one or more of a cosine similarity, clustering algorithm, or combinations thereof. Additionally and/or alternatively, in some examples, the analysis of the textual content by the supervised learning machine learned model can be based on one or more natural language models, including but not limited to, metric extraction, feature extraction, relationship extraction, or combinations thereof, and/or one or more of a cosine similarity, clustering algorithm, or combinations thereof, and/or other similar techniques.

In some examples, the unsupervised learning machine learned model can determine, based at least on one or more of the metric extraction, feature extraction, relationship extraction, cosine similarity, clustering algorithm, or combinations thereof, the content evaluation for the textual content. In some examples, the content evaluation determined by the unsupervised learning machine learned model can include a content score out of a plurality of content scores for the textual content, where the content score is selected from a plurality of predetermined values (e.g., 1, 2, 3, 4, 5, 6, etc.). In other words, the content score can be selected based on a predetermined value or score that the analysis believes the content is closest to, as compared to generating an individual score based on the unique factors of the content.

As described herein, in some examples, the textual content can be generated by a user in response to a prompt associated with a topic (e.g., a first topic, a second topic, etc.). In some examples, content evaluation of the textual content can be based at least in part on an assessment of an understanding by the user of the topic associated with the prompt. In some examples, the content evaluation of the textual content can be indicative of the user's understanding of the topic associated with the prompt. In some examples, the content evaluation can be indicative of and/or demonstrate a user's grammatical or formal technical writing skills and usage.

A display, communicatively coupled to the processor, can, in some examples, provide the content evaluation for manual updating, where the manual updating, in some examples, can include alteration of the content evaluation. In some examples, the alteration of the content evaluation can include an alteration of the content score.

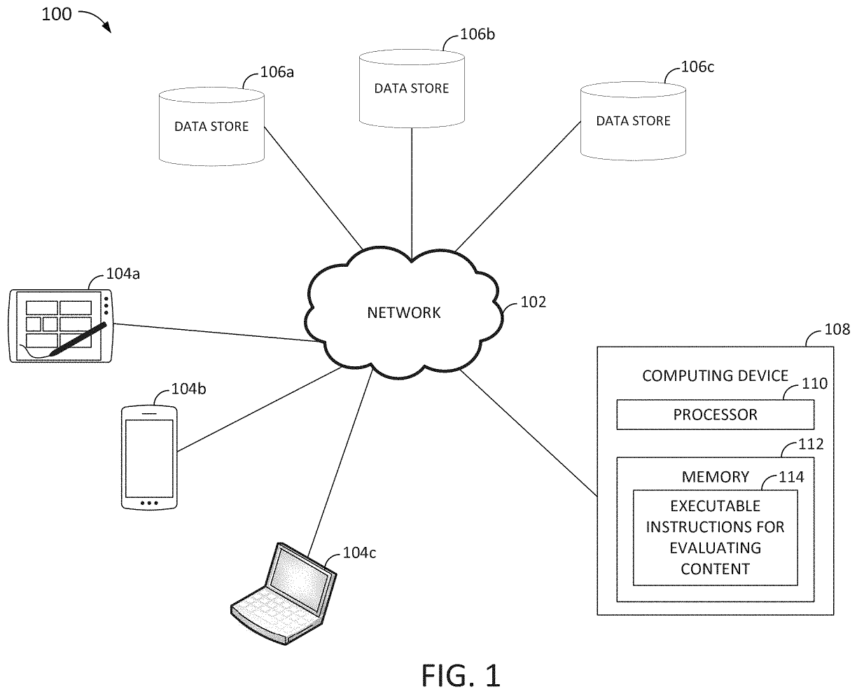

As one non-limiting example, the display can provide the content evaluation to an instructor (e.g., teacher, etc.) for manual alteration of the content evaluation. In some examples, no manual alterations may be made. In some examples, one or more alterations may be made to the content evaluation. In some examples, the altered or unaltered content evaluation is automatically transmitted to the student (e.g., a user of user devices 104 of FIG. 1) for display. In some examples, user devices 104 can alert the student via a notification or the like of the receipt of the content evaluation. In some examples, the content evaluation can be automatically sent to the student without manual alteration. In some examples, the content evaluation can be automatically sent to the student after manual alteration.

In this way, techniques described herein allow for the accurate, reliable, and efficient evaluation of textual content using a machine learned model.

Turning to the figures, FIG. 1 is a schematic illustration of an environment 100 in which a system for content evaluation using machine learning operates, in accordance with examples described herein. The system can reside, at least in part, on the computing device 108, in some implementations. It should be understood that this and other arrangements and elements (e.g., machines, interfaces, function, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more components may be carried out by firmware, hardware, and/or software. For instance, and as described herein, various functions may be carried out by a processor executing instructions stored in memory.

Environment 100 of FIG. 1 includes user devices 104a, 104b, and 104c (herein collectively known as user devices 104), data stores 106a, 106b, and 106c (e.g., a non-transitory storage medium) (herein collectively known as data stores 106), and computing device 108. Computing device 108 includes processor 110, and memory 112. Memory 112 includes executable instructions for evaluating content 114. It should be understood that environment 100 shown in FIG. 1 is an example of one suitable architecture for implementing certain aspects of the present disclosure. Additional, fewer, and/or alternative components may be used in other examples.

It should be noted that implementations of the present disclosure are equally applicable to other types of devices such as mobile computing devices and devices accepting gesture, touch, and/or voice input. Any and all such variations, and any combinations thereof, are contemplated to be within the scope of implementations of the present disclosure. Further, although illustrated as separate components of computing device 108, any number of components can be used to perform the functionality described herein. Additionally, although illustrated as being a part of computing device 108, the components can be distributed via any number of devices. For example, processor 110 may be provided by one device, server, or cluster of servers, while memory 112 may be provided via another device, server, or cluster of servers.

As shown in FIG. 1, user devices 104 and computing device 108 may communicate with each other via network 102, which may include, without limitation, one or more local area networks (LANs), wide area networks (WANs), cellular communications or mobile communications networks, Wi-Fi networks, and/or BLUETOOTH® networks. Such networking environments are commonplace in offices, enterprise-wide computer networks, laboratories, homes, educational institutions, intranets, and the Internet. Accordingly, network 102 is not further described herein. It should be understood that any number of user devices and/or computing devices may be employed within environment 100 and be within the scope of implementations of the present disclosure. Each may comprise a single device or multiple devices cooperating in a distributed environment. For instance, computing device 108 could be provided by multiple server devices collectively providing the functionality of computing device 108 as described herein. Additionally, other components not shown may also be included within the network environment.

User devices 104 and computing devices 108 can have access (via network 102) to at least one data store repository, such as data stores 106, which stores data and metadata associated with training a content evaluation machine learned model, as well as analyzing and evaluating textual content. For example, data stores 106 can store data and metadata associated with one or more of a plurality of textual training content (e.g., exemplar essays, etc.), including in some examples, a textual training content evaluation, including a training score and/or training comments, for each textual training content of the plurality of textual training content. In some examples, data stores 106 can store data and metadata associated with a minimum number of training textual content used to train, in some examples, the machine learned model using supervised learning. In some examples, data stores 106 can store data and metadata associated with a plurality of textual training content, used to train, in some examples, the machine learned model using unsupervised learning. In some examples, the textual training content stored in data stores 106 can include no content evaluation. In some examples, the textual training content stored in data stores 106 can include a partial content evaluation. In some examples, the textual content stored in data stores 106 can include a training content evaluation. In some examples, the training textual content stored in data stores 106 can include academic content, written content, one or more images, an essay, an article, a dissertation, a manuscript, a paper, a thesis, a treatise, an exposition, a composition, or combinations thereof.

Data stores 106 can further store data and metadata associated with textual content, in some examples, received by a user device, such as user devices 104. In some examples, the textual content stored in data stores 106 can include no content evaluation (e.g., no content score, no content comments, or combinations thereof). As one example, textual content stored in data stores 106 can include content scores but not content comments. In some examples, the textual content stored in data stores 106 can include a partial content evaluation. In some examples, the textual content stored in data stores 106 can include a content evaluation. In some examples, the textual content stored in data stores 106 can include academic content, written content, one or more images, an essay, an article, a dissertation, a manuscript, a paper, a thesis, a treatise, an exposition, a composition, or combinations thereof.

Data stores 106 can further store data and metadata associated with ground truth content (e.g., facts, quotes, images, dates, names, etc.). In some examples, the ground truth content can come from textbooks, movies, magazines, peer reviewed articles, and the like. In some examples, the ground truth content can include history, math, and science textbooks. In some examples, the ground truth content can include quotes from speeches or autobiographies. In some examples, the ground truth content can include dates and images from various timelines. In some examples, the ground truth can include facts, quotes, images, dates, names, etc. from the textual training content (e.g., from structured essays, unstructured essays, and the like). In some examples, the ground truth content can be hardcoded into data stores 106 by, for example, an instructor and/or a teacher. In some examples, the analysis of the textual content can be based at least in part on a comparison of extracted features and/or metrics to one or more ground truth content in data stores 106.

In implementations of the present disclosure, data stores 106 are configured to be searchable for the data and metadata stored in data stores 106. It should be understood that the information stored in data stores 106 can include any information relevant to content evaluation using a machine learned model, such as ground truth data, textual training content, textual content, and the like. As should be appreciated, data and metadata stored in data stores 106 can be added, removed, replaced, altered, augmented, etc., at any time, with different and/or alternative data. It should further be appreciated that each of data store 106a, 106b, and/or 106c can be updated, repaired, taken offline, etc. at any time without impacting the other data stores. It should further be appreciated that while three data stores are illustrated, additional and/or fewer data stores can be implemented and still be within the scope of this disclosure.

Information stored in data stores 106 can be accessible to any component of the disclosed system. The content and the volume of such information are not intended to limit the scope of aspects of the present technology in any way. Further, data stores 106 can be single, independent components (as shown) or a plurality of storage devices, for instance, a database cluster, portions of which can reside in association with computing device 108, user devices 104, another external computing device (not shown), another external user device (not shown), and/or any combination thereof. Additionally, data stores 106 can include a plurality of unrelated data repositories or sources within the scope of embodiments of the present technology. Data stores 106 can be updated at any time, including an increase and/or decrease in the amount and/or types of stored data and metadata.

Examples described herein can include user devices, such as user devices 104. User devices 104 may be communicatively coupled to various components of environment 100 of FIG. 1, such as, for example, computing device 108. User devices 104 can include any number of computing devices, including a head mounted display (HMD) or other form of AR/VR headset, a controller, a tablet, a mobile phone, a wireless PDA, touchless-enabled device, other wireless (or wired) communication device, or any other device capable of executing machine-language instructions. Examples of user devices 104 described herein can generally implement the receiving or collecting of textual content (e.g., from a student, teaching assistant, tutor, customer, administrator, user, etc. of the user device) as well as the transmission of the received and/or collected textual content to a computing device, such as computing device 108 for evaluation and analysis.

Examples described herein can include computing devices, such as computing device 108 of FIG. 1. Computing device 108 can in some examples be integrated with one or more user devices, such as user devices 104, described herein. In some examples, computing device 108 can be implemented using one or more computers, servers, smart phones, smart devices, tablets, and the like. Computing device 108 can implement textual content evaluation using machine learned model. As described herein, computing device 108 includes processor 110 and memory 112. Memory 112 includes executable instructions for content evaluation 114, which may be used to implement textual content evaluation using a machine learned model. In some embodiments, computing device 108 can be physically coupled to user devices 104. In other embodiments, computing device 108 may not be physically coupled user devices 104 but collocated with the user devices. In further embodiments, computing device 108 may neither be physically coupled to user devices 104 nor collocated with the user devices.

Computing devices, such as computing device 108 described herein, can include one or more processors, such as processor 110. Any kind and/or number of processor may be present, including one or more central processing unit(s) (CPUs), graphics processing units (GPUs), other computer processors, mobile processors, digital signal processors (DSPs), microprocessors, computer chips, and/or processing units configured to execute machine-language instructions and process data, such as executable instructions for content evaluation 114.

Computing devices, such as computing device 108, described herein can further include memory 112. Any type or kind of memory may be present (e.g., read only memory (ROM), random access memory (RAM), solid-state drive (SSD), and secure digital card (SD card)). While a single box is depicted as memory 112, any number of memory devices may be present. Memory 112 can be in communication (e.g., electrically connected) with processor 110. In many embodiments, the memory 112 can be non-transitory.

Memory 112 stores executable instructions for execution by the processor 110, such as executable instructions for content evaluation 114. Processor 110, being communicatively coupled to user device 104, and via the execution of executable instructions for content evaluation 114, analyzes textual content received from a user device, such as user devices 104, and determines a content evaluation for the textual content using a machine learned model.

In operation, to analyze received textual content using a machine learned model, processor 110 of computing device 108 executes executable instructions for evaluating content 114. As described herein, in some examples, textual content can include one or more of a plurality of words, and in some examples, the textual content can include academic content, written content, one or more images, an essay, an article, a dissertation, a manuscript, a paper, a thesis, a treatise, an exposition, a composition, or combinations thereof. Typically, textual content comprises content the evaluation of which is at least partially subjective, rather than simplistic evaluations of structured content, such as multiple choice answers, mathematical or numerical evaluations, or analysis of text strings or character strings. In some examples, the machine learned model can be trained using at least a plurality of textual content comprising textual training content. In some examples, the textual training content can include one or more of a plurality of words, and in some examples, the textual training content may include academic content, written content, one or more images, an essay, an article, a dissertation, a manuscript, a paper, a thesis, a treatise, an exposition, a composition, or combinations thereof. In some examples, the textual training content can include a training evaluation, including in some examples, a training score, training comments, or combinations thereof.

In some examples, the textual content can be generated in response to a prompt or question, such as in response to an examination on a particular subject, and can be used to demonstrate a user understanding of the particular subject. For example, the textual content can be generated by students during an examination process for qualifying examinations (e.g., bar exam, accounting qualifications, etc.) and/or within an academic environment, such as school. In some examples, the textual content can be generated by students answering a homework and/or assignment prompt and/or question. In some examples, the textual content can cover one topic. In some examples, the textual content can cover more than one topic. For example, the textual content can in some examples, cover anatomy of a hand (e.g., one topic). However, in some examples, the textual content can cover anatomy of the hand, wrist, and forearm (e.g., more than one topic).

In some examples, processor 110 of computing device 108 executes executable instructions for content evaluation 114 to analyze the textual content using a supervised learning machine learned model trained at least using a plurality of textual training content. In some examples, the analysis includes extracting features, metrics, or combinations thereof, of the textual content. In some examples, the analysis of the textual content by the supervised learning machine learned model using processor 110 can be based on performing metric extraction on the textual content, where the metric extraction includes extracting reading metrics, writing metrics, or combinations thereof, from the textual content. In some examples, the reading metrics are indicative of reading comprehension, including an understanding, an interpretation, or combinations thereof, of the textual content. In some examples, the reading metrics can be topic-specific. In some examples, the writing metrics are indicative of writing style, grammar, usage, structure, or combinations thereof. In some examples, the writing metrics can be topic-agnostic. In some examples, the metric extraction can include calculating one or more variable values characterizing metrics, such as for variables characterizing reading comprehension, writing style, grammar, usage, structure, and so forth.

In some examples, the analysis of the textual content by the supervised learning machine learned model using processor 110 can be based on performing feature extraction on the textual content. In some examples, the feature extraction can include determining the occurrence of language devices, inference verbs, common phrases, or combinations thereof in the textual content. In some examples, the feature extraction can include calculating one or more variable values characterizing features, such as for variables characterizing occurrence, count, or frequency of language devices, inference verbs, common phrases, and so forth.

In some examples, the extracted features can be based on the textual training content. In some examples, the extracted features can be predictive of the content score of the textual content. Examples of features that can be extracted include, but are not limited to, one or more of the following: word count (word_count), average length of each word (average_words_length), (num_stopword), (writer uses), average sentence length (average_sentence_length), semantic similarity top 3 (semantic_sim_top3), number of sentences (num_of_sentences), semantic similarity top 2 (semantic_sim_top2), average word length (avg_word_length), quote count (quotes_count), semantic similarity top 6 (semantic_sim_top6), semantic similarity top 4 (semantic_sim_top4), semantic similarity top 1 (semantic_sim_top1), semantic similarity top 5 (semantic_sim_top5), (florence s), semantic similarity top 10 (semantic_sim_top10), semantic similarity top 7 (semantic_sim_top7), (finds florence), semantic similarity top 8 (semantic_sim_top8), (oh di), (di finds), (did come), semantic similarity top p (semantic_sim_top9), (loving foolish), language structure (language structure), language use (uses language), (stopped short), (dear true), (true faithful), (moment florence), (faithful di), (entitiy_1_subjectivity_0), (little shadow), (phrase89), (old loving), (phrase85), (moment di), (di leave), (old loving foolish), (drying swollen), (short wheeled), (diogenes finds florence), (entity_2_relation_2), (faithful di did), (di did), (diogenes finds), and/or (leave di). The foregoing features can be characterized using variables.

In some examples, the analysis of the textual content by the supervised learning machine learned model using processor 110 can be based on performing TF-IDF on the textual content. In some examples, the TF-IDF includes determining a numerical statistic indicative of a level of importance for each of the one or more of words of the plurality of words in the textual content.

In some examples, the analysis of the textual content by the supervised learning machine learned model using processor 110 can be based on performing relationship extraction on the textual content. In some examples, the relationship extraction can include detecting and classifying a semantic relationship for each of the one or more words of the plurality of words in the textual content and each of a plurality of words in the plurality of textual training content.

In some examples, the analysis of the textual content by the supervised learning machine learned model using processor 110 can be based on performing semantic similarity on the textual content. In some examples, the semantic similarity can include determining a lexicographical similarity distance between each of the one or more words of the plurality of words in the textual content and each of a plurality of words in the plurality of textual training content. In some examples, the distance is indicative of similarity. In some examples, the semantic similarity is further based on a word mover's distance (WMD) algorithm, although additional and/or alternative algorithms are contemplated to be within the scope of this disclosure.

As described herein, in some examples, the analysis of the textual content by the supervised learning machine learned model using processor 110 can be based at least in part on a comparison of extracted features and/or metrics to one or more ground truth content in a data store, such as data stores 106. As should be appreciated, various techniques can be used and/or implemented to generate and/or curate the one or more ground truth content in data stores 106. In some examples, processor 110 can turn the training content (e.g., structured essays, unstructured essays) into relational knowledge graphs and/or relational databases to be used, in some examples, as the ground truth for the textual content analysis.

In some examples, based at least on one or more of the metric extraction, TF-IDF transformation, relationship extraction, semantic similarity, or combinations thereof, processor 110 can determine the content evaluation for the textual content. In some examples, the content evaluation can include a content score out of a plurality of content scores for the textual content. In some examples, the content score is a continuous variable.

In some examples, feedback from users (e.g., teachers, teaching assistants, professors, educators, students, administrators, etc.) can be collected. In some examples, the users can tag comments they make against a rubric. In some examples, this data can be used to train a model, e.g., the supervised (and others) model to reproduce feedback of the same quality. In some examples, such functionality can incorporate a Chatbot-style feature, where, in some examples, it enables users (e.g., students, etc.) to interact with it and ask questions. In some examples, the data can also be used to suggest feedback statements for users (e.g., teachers) to use during grading (e.g., marking).

As one example, a user (e.g., a teacher) may grade an essay and tag the sentences “Sikes is bad,” “Sikes is impatient,” “Sikes is mean,” “Sikes is brutal,” “Sikes is a barbaric character,” and/or “Sikes is abusive” with the description “Poor Understanding” and as a 2 out of 5 on the rubric. Such data can be used, as described herein, to train a model to reproduce feedback of the same quality, enable students to interact with a Chatbot-style feature to ask questions, and/or to suggest future comment feedback for teachers while grading. The trained model can then detect when a similar sentence is present in received textual content (e.g., by calculating a similarity score, a distance metric, and/or detecting keywords) and reproduce the description (e.g., “Poor Understanding”) and/or the score (e.g., “2 out of 5”).

In some examples, processor 110 of computing device 108 executes executable instructions for content evaluation 114 to analyze the textual content using an unsupervised learning machine learned model trained at least using a plurality of textual training content. In some examples, the analysis includes extracting features, metrics, or combinations thereof, of the textual content. In some examples, the analysis of the textual content by the unsupervised learning machine learned model can be based on performing metric extraction on the textual content. In some examples, the metric extraction can include extracting reading metrics, writing metrics, or combinations thereof, from the textual content. As described, in some examples, the reading metrics are indicative of reading comprehension, including an understanding, an interpretation, or combinations thereof, of the textual content. In some examples, the reading metrics can be topic-specific. In some examples, the writing metrics are indicative of writing style, grammar, usage, structure, or combinations thereof. In some examples, the writing metrics can be topic-agnostic.

In some examples, the analysis of the textual content by the unsupervised learning machine learned model using processor 110 can be based on performing feature extraction on the textual content. In some examples, the feature extraction can include determining the occurrence of language devices, inference verbs, common phrases, or combinations thereof in the textual content.

As described herein, in some examples, the extracted features can be based on the textual training content. In some examples, the extracted features can be predictive of the content score of the textual content. Examples of features that can be extracted include, but are not limited to, word count (word_count), average length of each word (average_words_length), (num_stopword), (writer uses), average sentence length (average_sentence_length), semantic similarity top 3 (semantic_sim_top3), number of sentences (num_of_sentences), semantic similarity top 2 (semantic_sim_top2), averate word length (avg_word_length), quote count (quotes_count), semantic similarity top 6 (semantic_sim_top6), semantic similarity top 4 (semantic_sim_top4), semantic similarity top 1 (semantic_sim_top1), semantic similarity top 5 (semantic_sim_top5), (florence s), semantic similarity top 10 (semantic_sim_top10), semantic similarity top 7 (semantic_sim_top7), (finds florence), semantic similarity top 8 (semantic_sim_top8), (oh di), (di finds), (did come), semantic similarity top p (semantic_sim_top9), (loving foolish), language structure (language structure), language use (uses language), (stopped short), (dear true), (true faithful), (moment florence), (faithful di), (entitiy_1_subjectivity_0), (little shadow), (phrase89), (old loving), (phrase85), (moment di), (di leave), (old loving foolish), (drying swollen), (short wheeled), (diogenes finds florence), (entity_2_relation_2), (faithful di did), (di did), (diogenes finds), and/or (leave di). The foregoing features can be characterized using variables.

In some examples, the analysis of the textual content by the unsupervised learning machine learned model using processor 110 can be based on performing relationship extraction on the textual content. In some examples, the relationship extraction can include detecting and classifying a semantic relationship for each of the one or more words of the plurality of words in the textual content and each of a plurality of words in the plurality of textual training content.

In some examples, the analysis of the textual content by the unsupervised learning machine learned model using processor 110 can be based on performing, using at least one or more of the metric extraction, feature extraction, relationship extraction, or combinations thereof, one or more of a cosine similarity, clustering algorithm, or combinations thereof. In some examples, the clustering algorithm is an agglomerative clustering algorithm, although additional and/or alternative algorithms are contemplated to be within the scope of this disclosure.

In some examples, at least one of the metric extraction, feature extraction, relationship extraction, or combinations thereof, can be normalized by the unsupervised learning machine learned model using processor 110. Various normalization techniques can be used, such as linear scaling, clipping, log scaling, z-score, re-scaling, min-max normalization, and so forth. It should be appreciated that while several normalization techniques are discussed, additional and/or alternative normalization techniques not discussed are contemplated to be within the scope of this disclosure.

As described herein, in some examples, the analysis of the textual content by the unsupervised learning machine learned model using processor 110 can be based at least in part on a comparison of extracted features and/or metrics to one or more ground truth content in a data store, such as data stores 106. As should be appreciated, various techniques can be used and/or implemented to generate and/or curate the one or more ground truth content in data stores 106. In some examples, processor 110 can turn the training content (e.g., structured essays, unstructured essays) into relational knowledge graphs and/or relational databases to be used, in some examples, as the ground truth for the textual content analysis.

In some examples, based at least on one or more of the metric extraction, feature extraction, relationship extraction, cosine similarity, clustering algorithm, or combinations thereof, processor 110 can determine the content evaluation for the textual content. In some examples, the content evaluation comprises a content score out of a plurality of content scores for the textual content. In some examples, the content score is selected from a plurality of predetermined values.

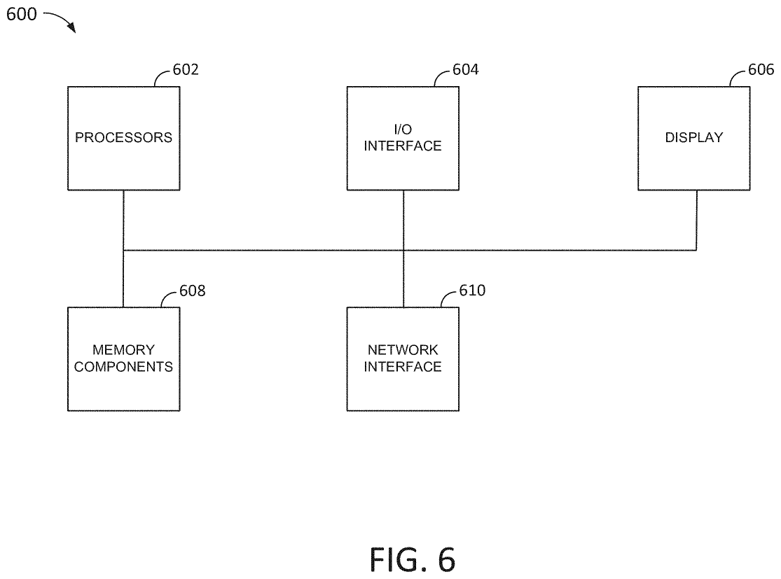

While not shown in FIG. 1, in some examples, a display, such as display 606 of FIG. 6, can provide the content evaluation for the textual content determined by the supervised learning machine learned model using processor 110, by the supervised learning machine learned model using processor 110, or combinations thereof, for manual updating. In some examples, the manual updating can include alteration of the content evaluation, including alteration of the content score for the textual content and/or content comments for the textual content. In some examples, the system can cause display of the determined content evaluation and concurrently cause display of one or more portions of the evaluated textual content to indicate reasons for the determined content evaluation. For example, if a content score was reduced due to the displayed one or more portions of the evaluated textual content, then the system causes display of the one or more portions of the evaluated textual content to allow a user (e.g., a teacher, instructor, or grader) to assess whether the content score should have been reduced due to the displayed one or more portions and to alter the content evaluation accordingly. In these and other implementations, the system can provide a graphical user interface (GUI) having a content evaluation region in which the content evaluation is displayed and a textual content region in which the one or more portions of the evaluated textual content is displayed. The GUI, thus, guides a user to relevant portions of the evaluated textual content to facilitate assessment of the content evaluation.

As should be appreciated, in some examples, the supervised learning machine learned model is used for the analysis and content evaluation determination. In some examples, the unsupervised learning machine learned model is used for the analysis and content evaluation determination. In some examples, a combination of the supervised learning machine learned model and the unsupervised machine learned model is used for the analysis and content evaluation determination.

In some examples, additional and/or alternative machine learned models are used for the analysis and content evaluation determination. In some examples, computing device 108, and/or processor 110 can determine which machine learned model or combination of machine learned models to use. In some examples, a user (e.g., an instructor) of computing device 108 can determine which machine learned model or combination of machine learned models to use. In some examples, a combination of computing device 108, and/or processor 110 and/or the user of computing device 108 model determine which machine learned model or combination of machine learned models to use.

In some examples, the textual content received by computing device 108 can be evaluated, stored in data stores 106, and subsequently used as additional and/or alternative training textual content.

As one non-limiting example, and in operation, a user (e.g., a student) of user devices 104 can draft textual content (e.g., an essay) using user devices 104. For example, the user can use a keyboard and/or other input device to input the textual content. The student can then upload the essay to computing device 108, via network 102. Another user or an evaluator (e.g., an instructor) of computing device 108 may wish to have the textual content analyzed. Computing device 108 analyzes the essay using one or more machine learned models utilizing processor 110, memory 112, and executable instructions for evaluating content 114. A content evaluation for the essay (e.g., a score, comments, or a combination thereof) can be determined for the student's essay. A display (e.g., display 606 of FIG. 6) provides the student's essay, including the score, comments, or a combination thereof, to the instructor for additional, optional, manual alteration. Optionally, the instructor then sends the evaluated essay back to the student, via network 102. In some examples, the manually altered content evaluation is automatically sent back to the student, via network 102.

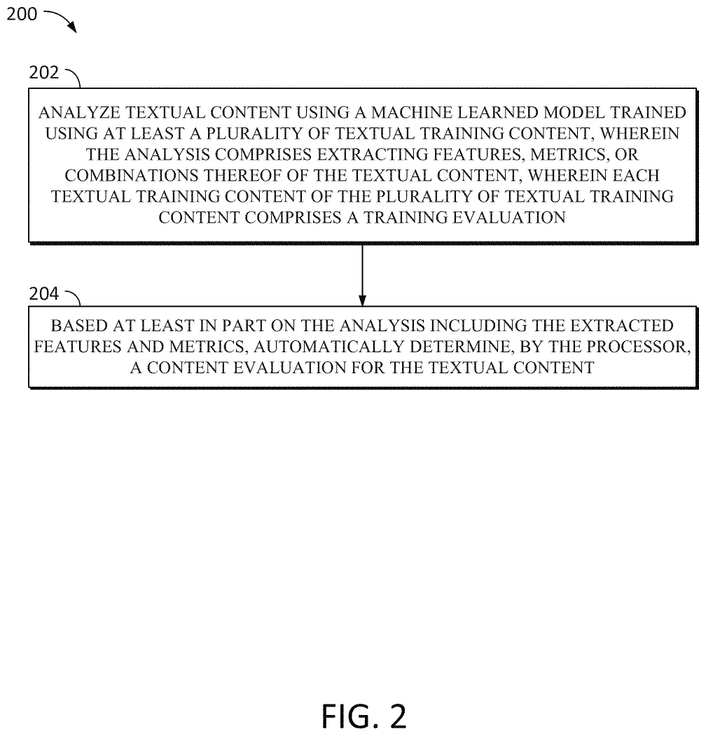

Now turning to FIG. 2, FIG. 2 is a flowchart of a method 200 for content evaluation using machine learning, in accordance with examples described herein. The method 200 can be implemented, for example, using the computing device 108 of FIG. 1 and/or computing system 600 of FIG. 6.

The method 200 includes analyzing textual content using a machine learned model trained using at least a plurality of textual training content, wherein the analysis comprises extracting features, metrics, or combinations thereof of the textual content, wherein each textual training content of the plurality of textual training content comprises a training evaluation in step 202; and based at least in part on the analysis including the extracted features and metrics, automatically determining, by the processor, a content evaluation for the textual content in step 204.

Step 202 includes analyzing textual content using a machine learned model trained using at least a plurality of textual training content, wherein the analysis comprises extracting features, metrics, or combinations thereof of the textual content, wherein each textual training content of the plurality of textual training content comprises a training evaluation. In some examples, the machine learned model is a supervised learning machine learned model. In some examples, the machine leaned model is an unsupervised learning machine learned model.

Step 204 includes, based at least in part on the analysis including the extracted features and metrics, automatically determining, by the processor, a content evaluation for the textual content. In some examples, the content evaluation comprises a content score out of a plurality of content scores for the textual content. In some examples, the content score is a continuous variable. In some examples, the content score is selected from a plurality of predetermined values. As described herein, the lack of machine learning application and implementation with respect to assisting with instructor efficiency in grading, as well as accuracy and reliability of assessment, of a student's work forces teachers and the like to rely exclusively on manual grading for evaluation of a student's work. Oftentimes, such manual review by individual graders is time consuming, leads to variable scores based on who the evaluator is, and can lead to inconsistent results across students. Advantageously, analyzing textual content using a machine learned model is a more desirable approach to content evolution, as it may facilitate a reduction in time spent on, and enhance the accuracy and reliability of content marking, leading to a more fair and unbiased content evaluation outcome.

In some implementations, the method 200 comprises training and/or retraining the machine learned model. For example, the disclosed system can generate one or more training datasets using the at least a plurality of textual training content. Generating the one or more training datasets can include extracting and/or determining one or more features or metrics from the textual training content, which can be expressed as variable values, as described herein. The trained machine learned model is then applied (e.g., at Step 202) to analyze the textual content. In some implementations, the trained machine learned model can then be evaluated to determine accuracy of the model. For example, a portion of the textual training content (e.g., 5%, 10%, 20%) can be held back as test data. The trained machine learned model can then be applied to the test data, and outputs of the model can be compared to expected outputs in the test data. When an accuracy of the trained machine learned model does not exceed a threshold accuracy level (e.g., 70%, 80%, 90%), then the trained machine learned model can be retrained, such as to account for model drift, changes in input data, and so forth. Retraining the model can include training the model at least a second time using the generated one or more training datasets and/or using a different training dataset. Additionally or alternatively, retraining the model can include adjusting one or more weights associated with the model.

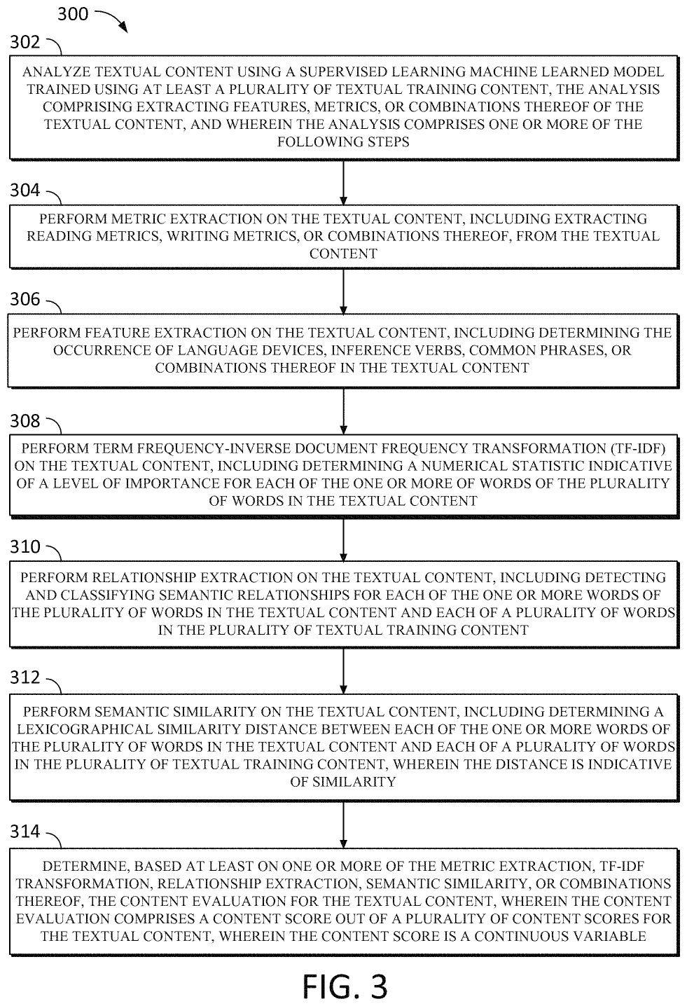

Now turning to FIG. 3, FIG. 3 is a flowchart of a method 300 for content evaluation using machine learning using a supervised learning machine learned model, in accordance with examples described herein. The method 300 may be implemented, for example, using the computing device 108 of FIG. 1 and/or computing system 600 of FIG. 6.

The method 300 includes analyzing textual content using a supervised learning machine learned model trained using at least a plurality of textual training content, the analysis comprising extracting features, metrics, or combinations thereof of the textual content, and wherein the analysis comprises one or more of the following steps in step 302; performing metric extraction on the textual content, including extracting reading metrics, writing metrics, or combinations thereof, from the textual content in step 304; performing feature extraction on the textual content, including determining the occurrence of language devices, inference verbs, common phrases, or combinations thereof in the textual content in step 306; performing term frequency-inverse document frequency transformation (TF-IDF) on the textual content, including determining a numerical statistic indicative of a level of importance for each of the one or more of words of the plurality of words in the textual content in step 308; performing relationship extraction on the textual content, including detecting and classifying a semantic relationship for each of the one or more words of the plurality of words in the textual content and each of a plurality of words in the plurality of textual training content in step 310; performing semantic similarity on the textual content, including determining a lexicographical similarity distance between each of the one or more words of the plurality of words in the textual content and each of a plurality of words in the plurality of textual training content, wherein the distance is indicative of similarity in step 312; and determining, based at least on one or more of the metric extraction, TF-IDF transformation, relationship extraction, semantic similarity, or combinations thereof, the content evaluation for the textual content, wherein the content evaluation comprises a content score out of a plurality of content scores for the textual content, wherein the content score is a continuous variable in step 314.

Step 302 includes analyzing textual content using a supervised learning machine learned model trained using at least a plurality of textual training content, the analysis comprising extracting features, metrics, or combinations thereof of the textual content, and wherein the analysis comprises one or more of the following steps.

Step 304 includes performing metric extraction on the textual content, including extracting reading metrics, writing metrics, or combinations thereof, from the textual content.

Step 306 includes performing feature extraction on the textual content, including determining the occurrence of language devices, inference verbs, common phrases, or combinations thereof in the textual content. As described herein, in some examples, the reading metrics are indicative of reading comprehension, including an understanding, an interpretation, or combinations thereof, of the textual content. In some examples, the reading metrics can be topic-specific. In some examples, the writing metrics are indicative of writing style, grammar, usage, structure, or combinations thereof. In some examples, the writing metrics can be topic-agnostic.

Step 308 includes performing term frequency-inverse document frequency transformation (TF-IDF) on the textual content, including determining a numerical statistic indicative of a level of importance for each of the one or more of words of the plurality of words in the textual content.

Step 310 includes performing relationship extraction on the textual content, including detecting and classifying a semantic relationship for each of the one or more words of the plurality of words in the textual content and each of a plurality of words in the plurality of textual training content.

Step 312 includes performing semantic similarity on the textual content, including determining a lexicographical similarity distance between each of the one or more words of the plurality of words in the textual content and each of a plurality of words in the plurality of textual training content, wherein the distance is indicative of similarity. In some examples, the semantic similarity is further based on a word mover's distance (WMD) algorithm.

Step 314 includes determining, based at least on one or more of the metric extraction, TF-IDF transformation, relationship extraction, semantic similarity, or combinations thereof, the content evaluation for the textual content, wherein the content evaluation comprises a content score out of a plurality of content scores for the textual content, wherein the content score is a continuous variable.

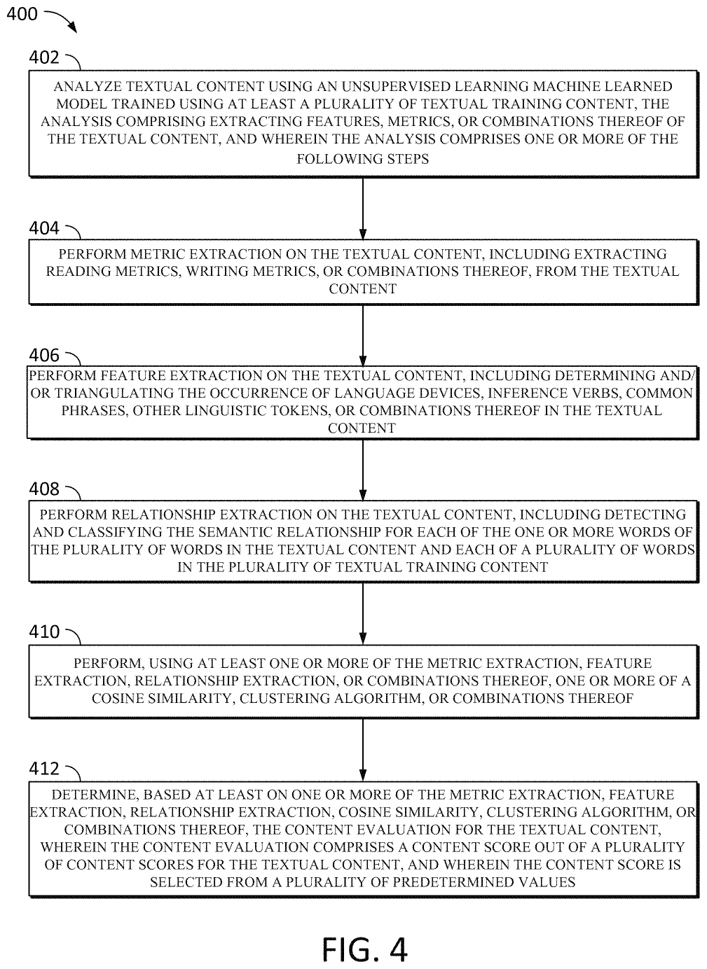

Now turning to FIG. 4, FIG. 4 is a flowchart of a method 400 for content evaluation using machine learning using an unsupervised learning machine learned model, in accordance with examples described herein. The method 400 can be implemented, for example, using the computing device 108 of FIG. 1 and/or computing system 600 of FIG. 6.

The method 400 includes analyzing textual content using an unsupervised learning machine learned model trained using at least a plurality of textual training content, the analysis comprising extracting features, metrics, or combinations thereof of the textual content, and wherein the analysis comprises one or more of the following steps in step 402; performing metric extraction on the textual content, including extracting reading metrics, writing metrics, or combinations thereof, from the textual content in step 404; performing feature extraction on the textual content, including determining the occurrence of language devices, inference verbs, common phrases, or combinations thereof in the textual content in step 406; performing relationship extraction on the textual content, including detecting and classifying a semantic relationship for each of the one or more words of the plurality of words in the textual content and each of a plurality of words in the plurality of textual training content in step 408; performing, using at least one or more of the metric extraction, feature extraction, relationship extraction, or combinations thereof, one or more of a cosine similarity, clustering algorithm, or combinations thereof in step 410; and determining, based at least on one or more of the metric extraction, feature extraction, relationship extraction, cosine similarity, clustering algorithm, or combinations thereof, the content evaluation for the textual content, wherein the content evaluation comprises a content score out of a plurality of content scores for the textual content, and wherein the content score is selected from a plurality of predetermined values in step 412.

Step 402 includes analyzing textual content using an unsupervised learning machine learned model trained using at least a plurality of textual training content, the analysis comprising extracting features, metrics, or combinations thereof of the textual content, and wherein the analysis comprises one or more of the following steps.

Step 404 includes performing metric extraction on the textual content, including extracting reading metrics, writing metrics, or combinations thereof, from the textual content. As described herein, in some examples, the reading metrics are indicative of reading comprehension, including an understanding, an interpretation, or combinations thereof, of the textual content. In some examples, the reading metrics may be topic-specific. In some examples, the writing metrics are indicative of writing style, grammar, usage, structure, or combinations thereof. In some examples, the writing metrics may be topic-agnostic, i.e., may apply across a range of topics or subjects, which may be contrasted with other variables which may be at least partially topic dependent.

Step 406 includes performing feature extraction on the textual content, including determining the occurrence of language devices, inference verbs, common phrases, or combinations thereof in the textual content.

Step 408 includes performing relationship extraction on the textual content, including detecting and classifying a semantic relationship for each of the one or more words of the plurality of words in the textual content and each of a plurality of words in the plurality of textual training content.

Step 410 includes performing, using at least one or more of the metric extraction, feature extraction, relationship extraction, or combinations thereof, one or more of a cosine similarity, clustering algorithm, or combinations thereof. In some examples, the clustering algorithm is an agglomerative clustering algorithm.

Step 412 includes determining, based at least on one or more of the metric extraction, feature extraction, relationship extraction, cosine similarity, clustering algorithm, or combinations thereof, the content evaluation for the textual content, wherein the content evaluation comprises a content score out of a plurality of content scores for the textual content, and wherein the content score is selected from a plurality of predetermined values.

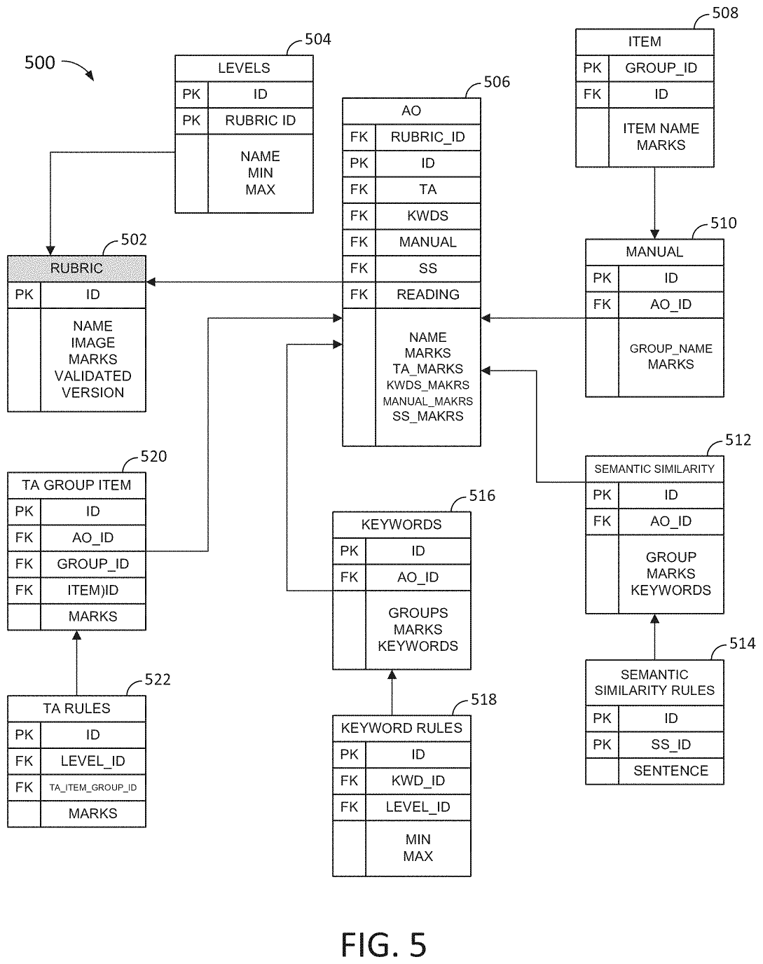

Now turning to FIG. 5, FIG. 5 is a block diagram of ground truth content in a structured relational knowledge graph in a relational data store, in accordance with examples descried herein. As described herein, in some examples, the analysis of the textual content by the supervised learning machine learned model and/or the unsupervised learning machine learned model, using a processor, such as processor 110 of FIG. 1, may be based at least in part on a comparison of extracted features and/or metrics to one or more ground truth content in a data store, such as data stores 106 of FIG. 1. As noted herein, various techniques can be used and/or implemented to generate and/or curate the one or more ground truth content in data stores 106. In some examples, processor 110 can turn the training content (e.g., structured essays, unstructured essays) into relational knowledge graphs and/or relational databases to be used, in some examples, as the ground truth for the textual content analysis and/or as part of one or more training datasets.

Although the methods 200, 300, and 400 include steps that are depicted as being performed in a particular order, the steps can be performed in a different order while maintaining a similar functionality. For example, steps can be added to or removed from the methods 200, 300, and 400, and/or one or more steps can be repeated. Furthermore, the methods 200, 300, and 400 and/or steps thereof can be performed in parallel (e.g., wherein performance of at least a portion of the methods overlaps in time at least in part). For example, one or more methods can be performed in parallel on multiple textual contents or a same textual content. In these and other implementations, a user (e.g., a teacher, instructor, or grader) can use the disclosed system to perform content evaluations on multiple textual contents (e.g., multiple student essays) at the same time, thus saving time that would otherwise be spent performing manual content evaluations. Additionally or alternatively, the user can use the disclosed system to perform content evaluations of the same textual content using multiple models (e.g., to compare results and/or increase accuracy of the evaluation).

In some examples, relational knowledge graph 500 can include rubric 502, levels 504, AO 506, item 508, manual 510, semantic similarity 512, semantic similarity rules 514, keywords 516, keyword rules 518, TA group item 520, and/or TA rules 522. Each of levels 504, AO 506, item 508, manual 510, semantic similarity 512, semantic similarity rules 514, keywords 516, keyword rules 518, TA group item 520, and/or TA rules 522, or combinations thereof, may be used to generate a ground truth rubric, such as rubric 502.

In some examples, the one or more ground truth content such as relational knowledge graphs and/or relational databases described herein can be generated using natural language processing (NLP). In some examples, a document (e.g., training content, textual content, etc.) ingestion pipeline can be used to receive, fetch, etc., training and/or textual content to use for ground truth. In some examples, the training and/or textual content can be provided by a user (e.g., student, teacher, administrator, end user, customer, client, etc.). In some examples, the ingestion pipeline can fetch the training and/or textual content.

In some examples, an NLP tool and accompanying library and, in some cases, dependency parsing, can be used to provide a set of annotations, such as, for example, sentence segmentation, tokenization, stemming, lemmatization, part of speech tagging, and/or dependency parsing. The dependency parsing can, in some examples, provide for a cross-linguistically consistent description of grammatical relations among tokens in a sentence that can, in some examples, be easily understood and/or used by users without linguistic knowledge.

In some examples, a named entity recognition (NER) model can be used for recognizing entities (e.g., key entities) in the training and/or textual content. In some examples, a graph model (e.g., proper graph model) can be used to store hidden structures extracted from the training and/or textual content (e.g., an essay) to query a data structure. In some examples, a graph database can be used for persisting the dependency relationships as an intermediate step. In some examples, an additional and/or alternative graph database can be used for storing an inferred knowledge graph. In some examples, relevant knowledge can be kept in one database as a knowledge graph, and detailed metadata can be kept in the same and/or an alternative database. In some examples, a visualization tool can be used on top of the knowledge graph to deliver, e.g., via display 606 of FIG. 6, insights to a user (e.g., customer, end user, administrator, teacher, student, etc.).

As one example, and in operation, ground truth can be generated and/or curated by, using for example, processor 110 of FIG. 1, the ingestion pipeline receiving and/or fetching training and/or textual content from one or more sources as described herein. An NLP tool with, in some examples, and NER can extract entities from the received or fetched training and/or textual content. A token occurrence writer can, in some examples, write a token dependency graph (e.g., into a metadata database). A rule-based relation extraction tool can extract relationships based on provided rules, in, for example, a JSON (or other applicable) format. A keyword extraction tool can, in some examples, run keyword and key phrase extraction algorithm(s) to extract keywords and/or key phrases from the training and/or textual content. The results can, in some examples, be stored as a knowledge graph, such as structured relational knowledge graph 500 of FIG. 5. In this way, a knowledge graph, such as structured relational knowledge graph 500 of FIG. 5, can be generated (in some examples, automatically) from received and/or fetched training and/or textual content rather than relying on human-curated knowledge.

Now turning to FIG. 6, FIG. 6 is a schematic diagram of an example computing system 600 for implementing various embodiments in the examples described herein. Computing system 600 can be used to implement the user devices 104, computing device 108, and/or it may be integrated into one or more of the components of disclosed system, such as using user devices 104 and/or computing device 108. Computing system 600 can be used to implement or execute one or more of the components or operations disclosed in FIGS. 1-4. In FIG. 6, computing system 600 can include one or more processors 602, an input/output (I/O) interface 604, a display 606, one or more memory components 608, and a network interface 610. Each of the various components can be in communication with one another through one or more buses or communication networks, such as wired or wireless networks.

Processors 602 can be implemented using generally any type of electronic device capable of processing, receiving, and/or transmitting instructions. For example, processors 602 can include or be implemented by a central processing unit, microprocessor, processor, microcontroller, or programmable logic components (e.g., FPGAs). Additionally, it should be noted that some components of computing system 600 can be controlled by a first processor and other components can be controlled by a second processor, where the first and second processors may or may not be in communication with each other.

Memory components 608 can be used by computing system 600 to store instructions, such as executable instructions discussed herein, for the processors 602, as well as to store data, such as textual training content, textual content, and the like. Memory components 608 can be, for example, magneto-optical storage, read-only memory, random access memory, erasable programmable memory, flash memory, or a combination of one or more types of memory components.

Display 606 provides a content evaluation, in some examples, including a content score and/or content comments, to a user of computing device 108 of FIG. 1 for manual alteration. Optionally, display 606 can act as an input element to enable a user of computing device 108 to manually alter the content evaluation, or any other component in the disclosed system as described in the present disclosure. Display 606 can be a liquid crystal display, plasma display, organic light-emitting diode display, and/or other suitable display. In embodiments where display 606 is used as an input, display 606 can include one or more touch or input sensors, such as capacitive touch sensors, a resistive grid, or the like.

The I/O interface 604 allows a user to enter data into the computing system 600, as well as provides an input/output for the computing system 600 to communicate with other devices or services, user devices 104 and/or computing device 108 of FIG. 1. I/O interface 604 can include one or more input buttons, touch pads, track pads, mice, keyboards, audio inputs (e.g., microphones), audio outputs (e.g., speakers), and so on.

Network interface 610 provides communication to and from the computing system 600 to other devices. For example, network interface 610 can allow user devices 104 to communicate with computing device 108 through a communication network, such as network 102 of FIG. 1. Network interface 610 includes one or more communication protocols, such as, but not limited to Wi-Fi, Ethernet, Bluetooth, cellular data networks, and so on. Network interface 610 can also include one or more hardwired components, such as a Universal Serial Bus (USB) cable, or the like. The configuration of network interface 610 depends on the types of communication desired and can be modified to communicate via Wi-Fi, Bluetooth, and so on.

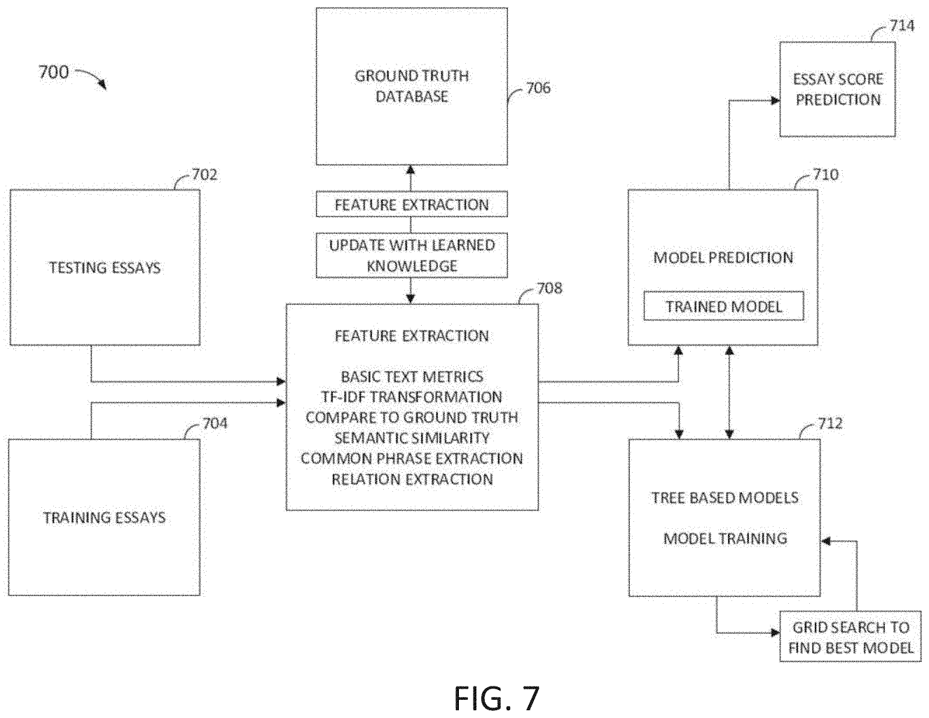

Turning now to FIG. 7, FIG. 7 is a block diagram illustrating content evaluation system 700 using machine learning as described herein. Content evaluation system 700 is described herein, and in some examples can include testing essays (e.g., textual content) 702, training essays (e.g., training textual content) 704, ground truth database 706, feature extraction 708, model prediction 710, tree-based models and model training 712, and essay score prediction 714.

As should be appreciated, embodiments and examples described herein generally relate to systems and methods for content evaluation, and more specifically, for analyzing textual content, such as essays, written work product, or the like, to determine a textual content evaluation, comprising a content score, using a machine learned model trained via supervised learning, unsupervised learning, or combinations thereof. In some examples, a machine learned model (e.g., a machine learning computer model) can be configured to evaluate (e.g., automatically in some examples) textual content including but not limited to open-ended textual responses to a prompt.

In some examples, the machine learned model can comprise an active learning interface that can be configured to collect and/or extract input features (e.g., input features manually input and/or hard coded by a user). In some examples, users can include but are not limited to teachers, administrators, students, and the like.

In some examples, the machine learned model can comprise an active learning interface that allows users (e.g., humans, etc.) to control input features and desired output features.

In some examples, the machine learned model can comprise an automated ground truth relation database generator.

In some examples, the machine learned model can comprise a machine learned model that compares to input textual.

In some examples, the machine learned model can comprise a predictive in-text domain-specific entity recognition engine.

In some examples, the machine learned model can comprise a surface-level language checker engine.

In some examples, the machine learned model can comprise a domain-specific predictive content evaluation engine.

In some examples, the machine learned model can comprise an automated diagnostic feedback generator.

In some examples, the machine learned model can comprise a diagnostic text-analytics dashboard, which in some examples, may include a graphical user interface (e.g., GUI) that in some examples can be displayed by, for example, display 606 of FIG. 6.

In some examples, the machine learned model can comprise an adaptive game-based learning engine.

In some examples, a machine learned model and/or computer assisted model can be configured to identify technical accuracy, strengths, and weaknesses of textual content, including for example, open-ended textual responses to a prompt, questions, or the like. In some examples, the computer assisted model can be further configured to generate diagnostic feedback in relation to the technical accuracy, strengths, and weaknesses. In some examples, the computer assisted model can be further configured to identify content (e.g., textual content, training textual content, etc.) related to at least the strengths and weaknesses. In some examples, the computer assisted model can be further configured to generate (e.g., automatically, manually, etc.) diagnostic domain-specific feedback wherein the content strengths and weaknesses are generated by utilizing, for example, transfer learning. In some examples, transfer learning can be based on one or more transformer models, each comprised of, in some examples, an encoder, a decoder, or combinations thereof, such as but not limited to BERT or generative pre-trained transformer three (GTP-3).

In some examples, the computer assisted model can be further configured to auto-tag and/or automatically tag within domain-specific entities by using a supervised learning machine learned model trained on data collected on a user interface. In some examples, the computer assisted model can be further configured to generate feedback based on what has been auto-tagged. In some examples, the computer assisted model can be further configured to auto-tag and/or automatically tag domain-specific entities for the purpose of analyzing and/or evaluating text to generate domain-specific feedback. In some examples, the computer assisted model can be further configured to rank order(s) written content in order of similarity against, for example, exemplar textual content in relation to a plurality of reading metrics, writing metrics, or combinations thereof.

In some examples, the computer assisted model and/or the machine learned models described herein can perform, or assist in performing the following operations: receiving one or more exemplar essays (e.g., rubrics, training textual contents, etc.), extracting metrics from the exemplar essays, rank order the extracted metrics in order of predictions (e.g., grade), generate a mark (e.g., score), and generate feedback on the extracted metrics against the exemplar essay.

In some examples, the computer assisted model can be further configured to generate a computer-assisted grade and computer-generated feedback. In some examples, the computer model can further extract the metrics from one or more exemplar essays, texts, textual responses, and the like, and compare the submitted textual responses to the exemplar textual response. In some examples, the metrics mean both content-related and technical accuracy metrics. In some examples, the productiveness means to create weightings used to model the computer-generated grade and feedback.

In some examples, a user interface as described herein can be configured to feed data collected from users into a ground truth database. In some examples, the data fed into the ground truth database can power a supervised machine learned model, wherein the data includes but is not limited to grades, scores, marks, technical accuracy feedback, and/or domain-specific content evaluation feedback, and the like, or combinations thereof.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods can be practiced. These embodiments are described in sufficient detail to enable those skilled in the art to practice presently disclosed systems and methods, and it is to be understood that other embodiments may be utilized, and that structural and logical changes can be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications can be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention can be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein can be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method for evaluating textual content, the method comprising:
analyzing, by a processor communicatively coupled to memory, textual content using a machine learned model trained using at least a plurality of textual training content, wherein the analysis comprises extracting features, metrics, or combinations thereof of the textual content, wherein the textual content comprises one or more words of a plurality of words, and wherein each textual training content of the plurality of textual training content comprises a training evaluation; and
based at least in part on the analysis including the extracted features and metrics, automatically determining, by the processor, a content evaluation for the textual content.

2. The method of claim 1, further comprising
providing, by a display communicatively coupled to the processor, the content evaluation for manual updating, wherein the manual updating includes alteration of the content evaluation, wherein the content evaluation comprises a content score out of a plurality of content scores for the textual content.

3. The method of claim 1, wherein the machine learned model is a supervised learning
machine learned model, and wherein the analysis of the textual content using the supervised learning machine learned model comprises one or more of the following:
performing, by the processor, metric extraction on the textual content, wherein the metric extraction includes extracting reading metrics, writing metrics, or combinations thereof, from the textual content;
performing, by the processor, feature extraction on the textual content, wherein the feature extraction includes determining and/or triangulating at least one occurrence of a language device, an inference verb, a common phrase, an other linguistic token, or combinations thereof in the textual content;
performing, by the processor, term frequency-inverse document frequency transformation (TF-IDF) on the textual content, wherein the TF-IDF includes determining a numerical statistic indicative of a level of importance for each of the one or more of words of the plurality of words in the textual content;
performing, by the processor, relationship extraction on the textual content, wherein the relationship extraction includes detecting and classifying semantic relationships for each of the one or more words of the plurality of words in the textual content and each of a plurality of words in the plurality of textual training content;
performing, by the processor, semantic similarity on the textual content, wherein the semantic similarity includes determining a lexicographical similarity distance between each of the one or more words of the plurality of words in the textual content and each of a plurality of words in the plurality of textual training content, wherein the distance is indicative of similarity; or
determining, by the processor and based at least on one or more of the metric extraction, TF-IDF transformation, relationship extraction, semantic similarity, or combinations thereof, the content evaluation for the textual content, wherein the content evaluation comprises a content score out of a plurality of content scores for the textual content, wherein the content score is a continuous variable.

4. The method of claim 3, further comprising performing, by the processor, relationship extraction on the textual content, wherein the relationship extraction includes detecting and classifying semantic relationships between lexical tokens for each of the one or more lexical tokens in the textual content and each of a plurality of lexical tokens in the plurality of textual training content, wherein each the textual content and the textual training content further comprise one or more of the plurality of lexical training tokens.

5. The method of claim 4, further comprising performing, by the processor, techniques comprising bidirectional encoder representations from transformers (BERT), chunking, tokenization, lemmatization, or combinations thereof, to determine the numerical statistic indicative of the level of importance for each of the one or more of words of the plurality of words in the textual content.

6. The method of claim 3, wherein the reading metrics are indicative of reading comprehension, including an understanding, an interpretation, or combinations thereof, of the textual content, wherein the reading metrics are topic-specific.

7. The method of claim 3, wherein the writing metrics are indicative of writing style, grammar, usage, structure, or combinations thereof, wherein the writing metrics are topic-agnostic.

8. The method of claim 3, wherein the semantic similarity is further based on a word mover's distance (WMD) algorithm.

9. The method of claim 1, wherein the machine learned model is an unsupervised learning machine learned model, and wherein the analysis of the textual content using the unsupervised learning machine learned model comprises one or more of the following:
performing, by the processor, metric extraction on the textual content, wherein the metric extraction includes extracting reading metrics, writing metrics, or combinations thereof, from the textual content;
performing, by the processor, feature extraction on the textual content, wherein the feature extraction includes determining and/or triangulating the occurrence of language devices, inference verbs, common phrases, other linguistic tokens, or combinations thereof in the textual content;
performing, by the processor, relationship extraction on the textual content, wherein the relationship extraction includes detecting and classifying the semantic relationship for each of the one or more words of the plurality of words in the textual content and each of a plurality of words in the plurality of textual training content;
performing, by the processor and using at least one or more of the metric extraction, feature extraction, relationship extraction, or combinations thereof, one or more of a cosine similarity, clustering algorithm, or combinations thereof; or
determining, by the processor and based at least on one or more of the metric extraction, feature extraction, relationship extraction, cosine similarity, clustering algorithm, or combinations thereof, the content evaluation for the textual content, wherein the content evaluation comprises a content score out of a plurality of content scores for the textual content, and wherein the content score is selected from a plurality of predetermined values.

10. The method of claim 9, further comprising performing, by the processor, relationship extraction on the textual content, wherein the relationship extraction includes detecting and classifying semantic relationships between lexical tokens for each of one or more lexical tokens in the textual content and each of a plurality of lexical tokens in the plurality of textual training content, wherein each the textual content and the textual training content further comprise one or more of the plurality of lexical training tokens.

11. The method of claim 9, wherein the clustering algorithm is an agglomerative clustering algorithm.

12. The method of claim 9, further comprising:
performing, by the processor, a normalization on at least one of the metric extraction, feature extraction, relationship extraction, or combinations thereof.

13. The method of claim 1, wherein the textual content comprises academic content, written content, one or more images, an essay, an article, a dissertation, a manuscript, a paper, a thesis, a treatise, an exposition, a composition, or combinations thereof.

14. The method of claim 1, wherein the textual training content comprises academic content, written content, one or more images, an essay, an article, a dissertation, a manuscript, a paper, a thesis, a treatise, an exposition, a composition, or combinations thereof.

15. The method of claim 1, wherein the textual content is generated by a user in response to a prompt associated with a first topic, and wherein the content evaluation for the textual content is based at least in part on an assessment of the user's understanding of the first topic.

16. At least one non-transitory computer readable medium encoded with instructions that, when executed, cause a system to perform actions for evaluating textual content, the actions comprising:
analyzing the textual content using a machine learned model trained using textual training content, wherein the analysis comprises extracting features, metrics, or combinations thereof of the textual content, wherein the textual content comprises one or more words of a plurality of words, and wherein the textual training content comprises a training evaluation; and
based at least in part on the analysis including the extracted features and metrics, automatically determining a content evaluation for the textual content.

17. The non-transitory computer readable medium of claim 16, wherein the machine learned model is a supervised learning machine learned model, wherein the content evaluation comprises a content score out of a plurality of content scores for the textual content, and wherein the content score is a continuous variable.

18. The non-transitory computer readable medium of claim 16, wherein the machine learned model is an unsupervised learning machine learned model, wherein the content evaluation comprises a content score out of a plurality of content scores for the textual content, and wherein the content score is selected from a plurality of predetermined values.

19. The non-transitory computer readable medium of claim 16, the actions further comprising:
providing the content evaluation for the textual content for manual updating, wherein the manual updating includes alteration of the content evaluation.

20. The non-transitory computer readable medium of claim 16, wherein the textual content comprises academic content, written content, one or more images, an essay, an article, a dissertation, a manuscript, a paper, a thesis, a treatise, an exposition, a composition, or combinations thereof, and wherein the textual training content comprises academic content, written content, one or more images, an essay, an article, a dissertation, a manuscript, a paper, a thesis, a treatise, an exposition, a composition, or combinations thereof.
